(19) United States
(12) Patent Application Publication
(10) Pub. No.: US 2004/0025581 A1
(43) Pub. Date: Feb. 12, 2004

(54) Method and apparatus for monitoring tire pressure with a color indicator

(76) Inventor: Laurence Dean Miller, Yorba Linda, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/464,154

(22) Filed: Jun. 17, 2003

Related U.S. Application Data
(63) Continuation-in-part of application No. 10/215,179, filed on Aug. 8, 2002.

(51) Int. Cl. G01M 17/02

(52) U.S. Cl. 73/146

(57) ABSTRACT

Disclosed herein is a method and apparatus for monitoring the air pressure of a tire. Various colors are displayed by the apparatus to denote an inflation level of the tire, and the apparatus may remain coupled to the air nozzle of a tire indefinitely. The apparatus includes a diaphragm that deforms in response to an air pressure differential on opposing sides thereof. Deformation of the diaphragm may alter the position of a color indicating cup, such that a color is displayed through an observation window, informing a user as to the inflation state of the tire. An LED circuit is provided for indicating a low tire pressure condition.

### RELATED APPLICATIONS

This is a continuation-in-part application of a prior filed and currently pending application having Ser. No. 10/215,179 and file date of Aug. 8, 2002.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

1. Field of the Invention

The present invention relates to devices for monitoring air pressure in tires and more particularly, the invention relates to a method and apparatus for monitoring air pressure in tires utilizing colors to indicate a level of tire pressure. In further embodiments, the invention relates to the monitoring of air pressure in high pressure tires.

2. Description of Related Art

Below optimum air pressure in the tires of automobiles, motorcycles and trucks is frequently associated with poor gas mileage, an increased risk of traffic accidents and greater wear on the tires themselves. Similarly, low tire pressure on other, non motorized vehicles, such as bicycles and trailers, can have similar ramifications; increased risk of losing control of the vehicle and more rapid deterioration of the tires. It is therefore generally advantageous to maintain at least near optimum air pressure in the tires of a vehicle or other transportation apparatus.

Monitoring tire pressure can be an inconvenient task, and individuals oftentimes forsake safety and fuel economy for time savings. Manual pressure gauges may require one to remove a cap from an air nozzle, couple the gauge to the nozzle, observe an indication of tire pressure from the gauge, remove the gauge and reattach the cap to the nozzle. This arduous task must then be repeated for every tire on the vehicle; especially burdensome on a vehicle with many tires, such as large trucks that may have eighteen or more tires.

A limitation of many conventional tire pressure monitoring devices is their inability to function properly at high tire pressures (i.e., pressures above about 60 psi). When subjected to such high pressures, conventional devices may be unable to accurately indicate an inflation level of a tire, or, more dramatically, they may fail altogether and mechanically rupture. A large sector of the tire pressure monitoring market is therefore unable to take advantage of this technology; in particular, the trucking industry, in which tire pressures are routinely at or above 60 psi. Since the problems associated with underinflated tires are particularly rampant in the trucking industry (i.e., poor gas mileage, premature tread loss, etc.), an adaptation to the conventional tire pressure monitoring technology is needed to address this limitation.

The following art defines the present state of this field:

Struby, U.S. Pat. No. 3,230,968 describes a combination comprising, hollow sleeve means including a rigid sleeve with a resilient body molded to the exterior of said sleeve adapted to secure said sleeve in an opening in the wall of an inflatable means, said sleeve extending substantially throughout the length of the resilient body, a hollow tube received for reciprocating movement within said sleeve with one end thereof projecting out of one end of said sleeve, sealing means sealing the other end of said hollow tube and said hollow sleeve means preventing the passage of air therebetween, a pressure actuated valve means mounted in said hollow tube, pressure responsive means for imparting a force to the other end of said hollow tube and having a resilient portion for biasing said hollow tube to project out of the other end of said hollow sleeve, means for indicating the extent of projection of said one end of said hollow tube out of said one end of said sleeve in accordance with the pressure encountered by the pressure responsive means, and adjusting means located at said other end of said tube for enabling axial adjustment of said tube relative to said rigid sleeve.

Webb, U.S. Pat. No. 3,450,147 describes a device that is mounted on the tubular valve stem of a pneumatic-tired vehicle and remains in place thereon to permit inflation of the tire and limitation of the pressure to which the tire can be inflated, which device includes an elongate rigid tubular body removably mounted on said valve stem and with an outer end thereof being adapted to be removably engaged by an sirdischarge fitting, which body is formed with at least one transverse port therein that is in communication with the interior of said body and the ambient atmosphere, the improvement for inflating said tire and limiting the air pressure therein, including: (a) a resilient poppet valve body through which a bore extends longitudinally, with said valve body having a frusto conical lower end that sealingly engages the outer end of said valve stem inwardly from said port and one poppet valve body disposed in said tubular body; (b) first deformed spring means in said tubular body that at all times urge said poppet valve body into sealing engagement with the outer end of said tubular valve stem inwardly from said port, which spring means permits outward movement of said poppet valve body to permit escape of surplus air from said tire through said bore when the air pressure in said tire exceeds a predetermined magnitude; (c) a abaft of smaller transverse cross section than that of said bore longitudinally disposed therein; (d) second spring means that at all times tend to move said shaft outwardly relative to said poppet valve body; and (e) a second rigid valve member on the inner end of said shaft which seals with the inner end of said poppet valve body except when said shaft is moved inwardly by said air-discharge fitting during the discharge of air into said tire, with said poppet valve body serving the dual function of permitting escape of surplus air at an excessive pressure from said tire through said port and as a seat for said rigid valve member.

Ashman, U.S. Pat. No. 3,572,283 describes a pressure-indicating cap for pneumatic tires comprising a base having an opening in its bottom end to engage a tire valve stem and to communicate with the inside of the tire, and a central upward tube portion having a sidewall fixed to the base and extending up about the opening so that the opening communicates with the inside of the tube portion, a cylindrical cover having a perforate top and a sidewall surrounding and spaced from the tube portion and sealed to the base, a portion of the sidewall of the cover being transparent, an annular indicating piston reciprocably disposed in the space between the tube sidewall and cover sidewall so that it can be seen at times through the window and a central piston disposed for reciprocation in the tube portion, the pistons each having sealing surfaces sealingly engaging the side walls along which they travel, spring means disposed between the top and each piston and biasing each piston toward the base, the tube portion having an opening in its side wall at a point above the level of the sealing surface of the piston in the tube portion when that piston is at its lowest point of travel and below the sealing surface of the annular piston when that piston is at its lowest point of travel.

Seaberg, U.S. Pat. No. 3,670,688 describes a pressure-indicating composite valve stem for mounting in the valve stem opening of tubeless tire rims is taught. The valve stem includes a central rigid tubular stem member. A barrel housing extends about or around a portion of the length of the central tubular member, forming an elongated annular cavity about the tubular member. A lateral port in the wall of the central tubular member communicates with this cavity. The barrel housing has an annular band transparent window permitting view of pressure indicia within the barrel housing. A significant portion of the central tubular member extends below the barrel housing and is firmly bonded to a unitary elastic body. This elastic body also is firmly bonded to the lowermost portion of the barrel housing and forms a hermetic seal over the junction at the inner or lowermost end of the barrel and the tubular member. The elastic body is also provided with a neck portion and head portion for mounting purposes in the tubeless tire rim. Within the cavity between the barrel housing and tubular member is a pressure-indicating assembly which includes a ring piston, a coil spring forcing the piston toward the bottom of the cavity nearest the rim mounting, a sleeve-like visual pressure indicator fixed to the piston and viewable through the window of the barrel housing, movable seals for maintaining an air tight condition as the piston slides, stop member to limit the motion of the piston, and means permitting atmospheric air passage from and to the outer end of the cavity as the piston slides therein.

Yabor, U.S. Pat. No. 3,789,867 describes an operatively attached constantly ready-for-use self-contained tire valve and companion air pressure indicating device having an elongated barrel or tube with an axial bore, said tube providing a core for the overall device. A normally closed conventional-type tire valve is telescopingly fitted within the outer screwthreaded end portion of the bore and is accessible for attachment and association therewith of an air pump hose. The outer end portion of the tube is externally screw-threaded to accomodate a protective screw cap and also a valving nut for air exhausting and bleeding as hereinafter set forth. The inner end portion of the tube is embedded air-tight in a central or axial portion of a rubber adapter base. The base is peripherally grooved and adapted to be lodged and retentively anchored in an opening provided therefor in a portion of the tire rim. Cylinder means surrounds a predetermined portion of the tube and more specifically comprises inner and outer concentric cylinders with the space therebetween providing a pressurized air trapping chamber. Inner end portions of the cylinders are also embedded in the base. The base has slots or openings allowing the air from the tune to pay back into the chamber. A spring-biased piston, is confined for sliding movement in the chamber and has suitable O-rings to provide shiftable but air-tight contact between inner and outer peripheral surfaces of the piston and cylinders. The outer cylinder has a graduated scale and the coordinating piston provides an indicator for measuring association with the graduations of the scale. Exhaust ports at the outer end and an opening and closing and valving nut on a threaded portion of the tube make it possible to exhaust air from the chamber to permit accurate operation of the indicator.

Bluem, U.S. Pat. No. 3,889,530 describes an air pressure testing apparatus connected to a conventional valve stem of a pneumatic tire that is operable to provide visual color information as to the pressure of the air in the tire. The apparatus has a body mounted on the valve stem. A transparent housing is mounted on the body. A spring biased annular piston located between the housing and body has color code information. Separate colors on the piston are visually observable through the transparent housing as determined by the longitudinal position of the piston relative to the beads. An elongated plunger extended through the body is movable to open the valve in the valve stem to subject the annular piston to the air pressure of the tire. If the air pressure is above a predetermined pressure, the piston will move changing the color code observable through the beads. If the air pressure is below the predetermined pressure, the piston will not move and the color code will remain the same. The plunger is movable to a position wherein air under pressure can be introduced into the tire.

Tanner et al., U.S. Pat. No. 3,994,312 describes an inflation pressure regulator which automatically releases pressure above a predetermined maximum. The regulator has a tubular base extending into the hollow interior of a housing. A collar slideably mounted on the tubular base is biased against the interior of the housing with a coil spring to regulate the pressure. An inflation gas is supplied through the neck of the housing which has a plunger extending through the tubular base. A threaded cavity in the base permits permanent installation on an inflation valve.

Parker, U.S. Pat. No. 4,310,014 describes a visual indication of low tire pressure, a valve stem comprising a base for mounting to a tire rim, an outer nipple portion containing a tire stem valve, and an intermediate convoluted portion connecting the base and the nipple. An inner extension of the nipple passes through the base portion and has its inner end secured to a spring which is compressed between the extension and the base portion to urge the nipple toward the tire rim against the force of the tire pressure so that the spacing of the nipple from the rim is a measure of tire pressure. A transparent cylinder surrounding the valve stem and secured to the base portion contains a window for viewing an indicia mark on the nipple, the indicia being placed to provide an indication of low tire pressure when it is visible through the window.

Leimbach, U.S. Pat. No. 4,445,527 describes a tire valve extension, which includes a relief valve element to limit the inflation pressure of the tire. The extension has a tubular body with an annular recess formed therein to define an outer tube section and an inner tube section. A spring loaded valve-actuating pin is received within the inner tube section, and the relief valve element is received within the recess. Ports formed in the body intersect a channel formed in the recess to define a relief flow path.

Yabor, U.S. Pat. No. 4,901,747 describes a tire valve with a tire air pressure indicator incorporated therein to provide a continuous visual indication of the air pressure within the tire. The tire valve includes a rigid tubular main stem having means on its inner end for mounting on a tire rim together with an external sleeve spaced from and sealingly engaged with the main stem to form an air chamber. A spring biased piston is slidably disposed in the air chamber for movement longitudinally therein with air passages communicating the interior of the stem with the air chamber with the air pressure in the tire also occurring in the air chamber thereby moving the piston outwardly by compressing a calibrated spring in accordance with the air pressure. The external sleeve is transparent and the piston serves as an indicator associated with a graduated scale on the sleeve to indicate the air pressure in the tire.

Bartholomew et al., U.S. Pat. No. 4,944,323 describes a visual tire pressure indicator having a hollow outer body, an inner cap fitted within the outer body and an inner body secured to the inner cap and generally co-axial with the outer body. A pair of indicator sleeves is slidably disposed around the inner body. A pre-calibrated spring helically surrounds the inner body for biasing or urging the pair of indicator sleeves towards the inner cap. A valve core body is threadably engaged to top threads of the inner body while simultaneously being fitted snugly against an inner wall of the inner body. The valve core body has a longitudinal bore wherethrough air is passed to be emitted into a tire. A control rod has a valve core cap secured thereto and is slidably disposed in the longitudinal bore such that when it is depressed, air can be passed through the longitudinal bore. A valve core spring is positioned around the control rod and in the longitudinal bore to bias the control rod such that the core cap can seal-off the longitudinal bore.

MacAnally et al., U.S. Pat. No. 4,951,501 describes a tire valve comprising a brass stem having an elongate insulating.sleeve over it, the sleeve being circumposed by a flanged threaded metal body which is provided with a gasket and a clamping nut to clamp the valve to the wheel. Electrically insulated from each other are a pair of contact rings held respectively against the clamping nut on the body and a second final nut contacting the stem, the rings having take-off leads. A molded rubber shroud protects the rings and holds them and an insulating spacer in proper relation.

Leeuwen, U.S. Pat. No. 5,027,848 describes a pressure indicating valve stem for a pneumatic tubeless tire comprising a tubular valve core holder, a mounting sleeve in which the core holder is capable of elastically restrained telescopic movement, a clamp nut threaded on said sleeve which in conjunction with an end flange on the sleeve secures it within the valve orifice of a wheel rim, and sealing means comprising an elastomeric generally tubular molding having an annular margin clamped between the end flange and the rim and its other end margin sealed to the inner end of the core holder. The molding has a large diameter undulating walled boot or bellows extending from one said end margin to the other, which provides all of the elastic restraint on the movement of the core holder within the sleeve.

Halcomb, U.S. Pat. No. 5,979,232 describes a tire pressure indicator carried on a tire being monitored for inflation pressure. The indicator includes a housing enclosing an indicating member bearing color coding corresponding to proper inflation. Preferably, additional color coding is provided corresponding to excessive tire pressure and to low or inadequate tire pressure. The indicating member occupies a chamber having a coil spring acting on the indicating member from one direction, and air pressure from the tire acting on the indicating member from the other direction. Differential in forces acting on the indicating member move the indicating member such that the appropriate color coding is revealed through a window formed in the housing. Optionally, the pressure indicator includes a conduit enabling inflation of the tire without requiring removal of the indicator. In alternative embodiments, the novel indicator threads to a conventional filling valve, and replaces the conventional filling valve.

The prior art teaches various tire pressure monitoring and indicating devices, but does not teach the use of an LED lamp for indicating low pressure condition. The present invention fulfills these needs and provides further related advantages as described in the following summary.

### SUMMARY OF THE INVENTION

The present invention teaches certain benefits in construction and use which give rise to the objectives described below.

It is therefore an object of an embodiment of the present invention to provide an apparatus for monitoring the air pressure of a tire that obviates, for practical purposes, the above-mentioned limitations. The apparatus of the present invention allows a user to monitor the air pressure of a tire, without the need to proceed through the series of steps enumerated above (i.e., removal of a cap, coupling of a device to an air nozzle, observation of a tire pressure reading, removal of the device, and subsequent reattachment of the cap). The apparatus may instead be coupled to the air nozzle of a tire, and may remain coupled to the nozzle for an indefinite period of time. Moreover, the apparatus of the present invention may monitor tire pressure in high pressure tires (i.e., those with an optimum pressure level at or above 60 psi; hereinafter “high pressure tires”).

The apparatus includes a diaphragm that deforms in response to an air pressure differential on opposing sides thereof. Deformation of the diaphragm alters the position of a color indicating cup or piston, such that a color is displayed through an observation window, informing a user as to the inflation state of the tire. In particular embodiments, the apparatus may display a first color when the tire pressure is near optimum, and a second color when the tire pressure is sufficiently low that it should be filled with air. In alternate embodiments, the apparatus may display yet a third color when the tire pressure is below optimum yet still in an acceptable range. A method of monitoring the air pressure of a tire utilizing the apparatus is further provided, as is a method for monitoring the air pressure of a high pressure tire. The apparatus and method provide for illumination of an LED when pressure in the tire is low.

A primary objective of the present invention is to provide an apparatus and method of use of such apparatus that provides advantages not taught by the prior art.

Another objective is to provide such an invention capable of displaying tire pressure condition.

A further objective is to provide such an invention capable of lighting an LED when the tire pressure is low.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a full vertical cross sectional view of the present invention wherein low tire pressure condition is indicated; and

FIG. 2 is a corresponding full vertical cross sectional view of the present invention wherein adequate tire pressure condition is indicated.

### DETAILED DESCRIPTION OF THE INVENTION

The above described drawing figures illustrate the invention in at least one of its preferred embodiments, which is further defined in detail in the following description.

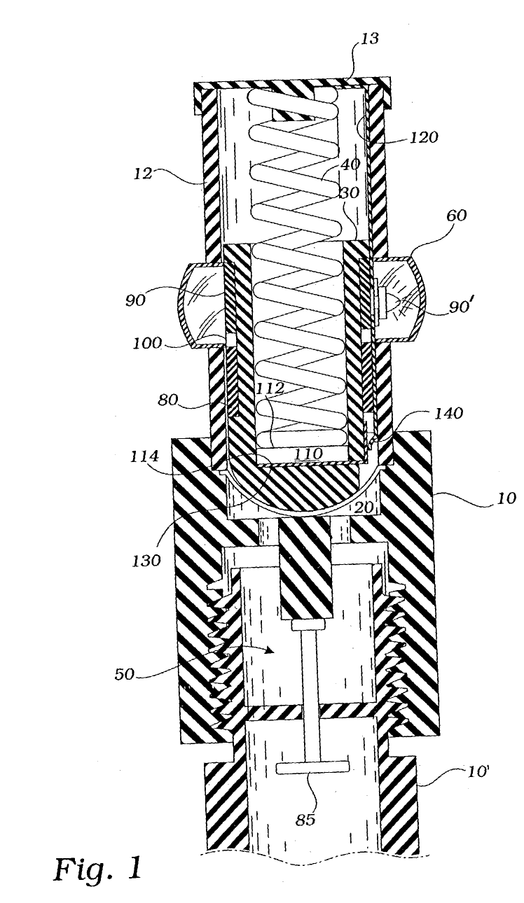

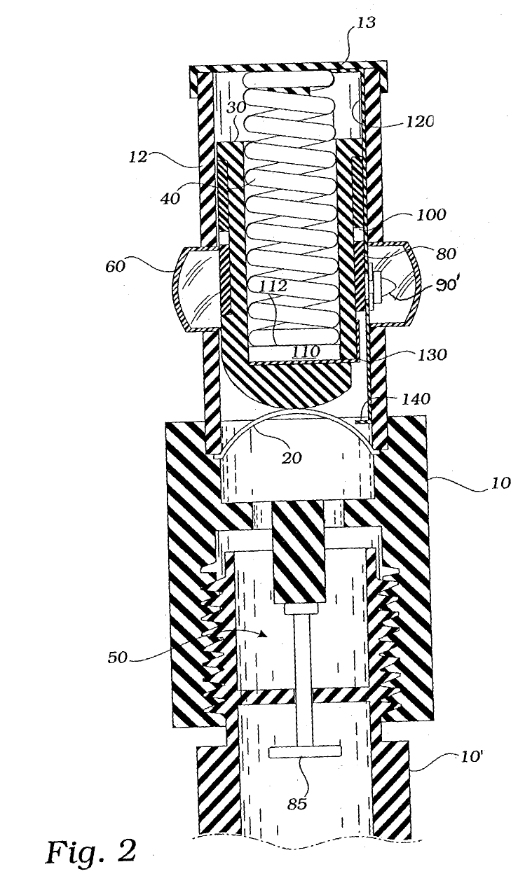

The present invention is a tire pressure monitoring apparatus, comprising a lower housing 10 of an electrically non-conducting material such as plastic, a diaphragm 20 of rubber or similar material, the diaphragm 20 clamped between the lower housing 10 and an upper housing 12, is configured within the housing 10 to deform in response to at least an air pressure differential thereacross. The upper housing 12 preferably is closed by a cap 13 that may be welded, bonded or threaded in place on the upper housing 12. The clamping of the diaphragm 20 enables an air tight seal of the diaphragm 20 between upper 12 and lower 10 housings. A color indicating piston 30 of an electrical non-conductor, is disposed in contact with the diaphragm 20 and is free to move longitudinally within the upper housing 12 into which it is slidingly fitted. The apparatus further provides a spring 40, such as the coil spring shown, but not limited thereto, of an electrically conducting material such as a metal, positioned for urging the piston 30 against the diaphragm 20 in a first deformed direction of the diaphragm 20 shown in FIG. 1, and an inlet 50 in the lower housing 10 providing, when in use, a tire air pressure against the diaphragm 20 in a second deformed direction, which is in opposition to the first deformed direction within the upper housing 12 and shown in FIG. 2. The color indicating piston 30 is visible through a transparent window 60 in the upper housing 12 for indicating status of an air pressure in a corresponding tire (not shown) having fluid communication with the inlet 50 to the housing 10. A valve stem actuator 85 within the inlet 50 is positioned for actuation of a tire valve 10′ when the apparatus is engaged therewith as shown in the figures. The valve stem of the tire valve 10′ is not depicted for clearity.

An electrical circuit, described below, within the housing 12 provides a means for illumination 90′ preferably a light emitting diode, such as those manufactured by Luxeon, Inc. of San Jose, Calif., and which are well known in the art. The circuit is made when the diaphragm 20 is fully deformed in the first deformed direction thereby indicating under-inflation of the tire. This occurs when the tire air pressure is not sufficient to move diaphragm 20 to the position shown in FIG. 2 thereby causing compression of spring 40.

Preferably, the piston 30 provides two color bands, green 80 and red 90, which indicate acceptable tire pressure and under-inflation respectively by being visible through the window 60 depending upon the longitudinal position of the piston 30. Alternately, three color bands may be used with yellow 100 indicating a marginal tire pressure condition by being positioned between the red and greed bands. Such bands 80, 90, 100 may be painted or printed onto an exterior surface of the piston. The bands may also be separate rings bonded or otherwise placed exteriorly on the piston 30.

Preferably, the electrical circuit comprises a battery 110, such as the well known disk type with opposing electrodes 112, 114 on opposing sides of the battery. Battery 110 is positioned between the spring 40 and the piston 30, the spring 40 making electrical contact with a first terminal 112 of the battery 110 at one end of the spring 40, and with a conductor 120 at the opposing end of the spring 40, as shown in the figures. Preferably the piston 30 is cup-shaped with the battery 110 placed within the piston 30 and thereby supported by the piston 30.

The electrical circuit further comprises an electrical conductor 130, as best seen in FIG. 2, in contact with a second terminal 114 of the battery, the electrical conductor 130 is positioned for making the electrical circuit when the diaphragm 20 is fully deformed in the first deformed direction whereby the illumination means 80 is illuminated. This is achieved by placing a contact terminal 140 on the inner surface of the upper housing 12 in such position as to enable physical contact between the conductor 130 and the terminal 140 when the diaphragm 20 is fully deformed in the first direction as stated above. The conductors 120 and 130 and the contact 140 are preferably made of beryllium copper or equivalent as thin metallic strips set into grooves in the upper housing 12, the cap 13 and the piston 30. The portion of contact 140 that is unsupported is of spring resilience so that it may move from its relaxed position, shown in FIG. 2, to its contact position shown in FIG. 1 without loosing its ability to flex appropriately each time piston 30 moves into the position shown in FIG. 1. Preferably conductor 110 may be configured to exit piston 30 at more than one location, such as three or four locations, and each would contact with the same number of conductors contactors 140, conductors 120 and LEDs 90′ so that the lit LED may be seen from any side of housing 12.

The method of the present invention comprises the steps of: providing the housing 10 configuring a diaphragm 20 within the housing to deform in response to air pressure differential across it; disposing the color indicating piston 30 in contact with the diaphragm 20 for being moved longitudinally within the housing 10; positioning the spring 40 for urging the piston 30 against the diaphragm 20 in the first direction (downward) and providing tire air pressure in the inlet to the housing 10 to provide a force to move the diaphragm 20 in the second direction (upward), in opposition to the first deformed direction, and placing the color indicating piston 30 so as to be visible through the transparent window in the housing for indicating status of an air pressure in a corresponding tire having fluid communication with the inlet to the housing. The method further provides an electrical circuit within the housing; lighting a means for illumination when the diaphragm is fully deformed in the second direction, for thereby indicating under-inflation of the tire.

The method further includes the steps of providing the valve stem within the inlet, and positioning the valve stem actuator for actuation of a tire valve with the housing engaged therewith; providing an outer surface of the housing with the two or three color bands; positioning the battery between the spring 40 and the piston 30, the spring making electrical contact with a first terminal of the battery 112, and providing the electrical circuit with the electrical conductor 120 in contact with a second terminal of the battery, and positioning the conductor 130 for making the circuit when the diaphragm 40 is fully deformed in the first deformed direction so that the battery 110 provides electrical current to the LED 90′ warning of low air pressure.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A tire pressure monitoring apparatus, comprising: a housing of an electrically non-conducting material; a diaphragm configured within said housing to deform in response to at least an air pressure differential thereacross; a color indicating piston of an electrical non-conductor, the piston disposed in contact with the diaphragm for being moved longitudinally within the housing; a spring of an electrically conducting material positioned for urging the piston against the diaphragm in a first deformed direction of the diaphragm; an inlet to the housing providing a tire air pressure against the diaphragm for urging the diaphragm in a second deformed direction, in opposition to the first deformed direction, wherein forces of the spring and the tire air pressure, together, determine the deformation position of the diaphragm and thus the position of the color indicating piston in the housing; portions of said color indicating piston positionable visibly through a transparent window in the housing for indicating status of the tire air pressure; an electrical circuit within the housing, the electrical circuit providing means for illuminating, the circuit made with the diaphragm fully deformed in the first deformed direction thereby indicating under-inflation of the tire.

2. The apparatus of claim 1 wherein the housing further comprises a valve stem actuator within the inlet and positioned for actuation of a tire valve engaged with the housing.

3. The apparatus of claim 1 wherein an outer surface of the piston provides two color bands; the bands indicating acceptable tire pressure and under-inflation respectively.

4. The apparatus of claim 3 wherein the two colors are green and red.

5. The apparatus of claim 1 wherein an outer surface of the piston provides three color bands; the bands indicating acceptable tire pressure, marginal tire pressure and under-inflation respectively.

6. The apparatus of claim 5 wherein the three colors are green, yellow and red.

7. The apparatus of claim 1 wherein the electrical circuit comprises a battery positioned between the spring and the piston, the spring making electrical contact with a first terminal of the battery.

8. The apparatus of claim 7 wherein the electrical circuit further comprises an electrical conductor in contact with a second terminal of the battery, the electrical conductor positioned for making the electrical circuit when the diaphragm is fully deformed in the first deformed direction whereby the illumination means is illuminated.

9. The apparatus of claim 8 wherein the illumination means is a high intensity light emitting diode.

10. The apparatus of claim 1 wherein the transparent window presents a convex surface exteriorly to the housing.

11. A tire pressure monitoring method, comprising the steps of: providing a housing of an electrical non-conductor; configuring a diaphragm within said housing to deform in response to at least an air pressure differential thereacross; disposing a color indicating piston of an electrical non-conductor, in contact with the diaphragm for being moved longitudinally within the housing; positioning a spring of an electrically conducting material for urging the piston against the diaphragm in a first deformed direction of the diaphragm; providing tire air pressure in an inlet to the housing, the air pressure providing a force against the diaphragm in a second deformed direction, in opposition to the first deformed direction within said housing; placing the color indicating piston so as to be visible through a transparent window in the housing for indicating status of the tire air pressure; providing an electrical circuit within the housing; lighting a means for illumination when the diaphragm is fully deformed in the first deformed direction thereby indicating under-inflation of the tire.

12. The method of claim 11 comprising the further step of providing a valve stem actuator within the inlet, positioned for actuation of a tire valve with the housing engaged therewith.

13. The method of claim 11 comprising the further step of providing an outer surface of the piston with two color bands; the bands indicating acceptable tire pressure and under-inflation respectively.

14. The method of claim 11 comprising the further step of providing an outer surface of the housing with three color bands; the bands indicating acceptable tire pressure, marginal tire pressure and under-inflation respectively.

15. The method of claim 11 comprising the further step of positioning a battery between the spring and the piston, the spring making electrical contact with a first terminal of the battery.

16. The method of claim 15 comprising the further step of positioning an electrical conductor in contact with a second terminal of the battery, the electrical conductor making the circuit when the diaphragm is fully deformed in the first deformed direction whereby the illumination means is illuminated.
